(19) United States
(12) Patent Application Publication
(10) Pub. No.: US 2026/0046340 A1
(43) Pub. Date: Feb. 12, 2026

(54) SERVICE ENHANCEMENT OF DEVICE AND APPLICATIONS THEREOF

(71) Applicant: Nokia Technologies Oy, Espoo (FI)

(72) Inventors: Zhi WANG, Qingdao (CN); Qing Bo ZHANG, Qingdao (CN); Guan Nan YANG, Qingdao (CN)

(21) Appl. No.: 19/100,291

(22) PCT Filed: Aug. 10, 2022
(86) PCT No.: PCT/CN2022/111578

§ 371 Date: Jan. 31, 2025

(51) Int. Cl. H04L 67/51

(52) U.S. Cl. CPC H04L 67/51

(57) ABSTRACT

Embodiments of the present disclosure relate to service enhancement of a device and applications thereof. A device causes a first application on the device to send. to an application registry on the device. a discovery request for discovering other applications. Then the device causes the application registry to determine, based on the discovery request. a second application registered in the application registry. Moreover, the device causes the application registry to send. to the first application. a discovery response indicating the second application. As a result. it is allowed to support service discovery on the device.

### FIELD

Various example embodiments relate to the field of telecommunication and in particular, to a method, a device, an apparatus, and a computer readable storage medium for service enhancement of a device and applications thereof.

### BACKGROUND

In recent years, smart devices and ecosystem hardware have experienced not only explosive growth but also enormous diversification. A variety of smart devices (for example, a watch, an earphone, a smart speaker, a smart TV, a smart refrigerator and a smart car, etc.) are productized for customized requirements and become increasingly popular in people's daily lives. For example, it is reported that the shipments of the worldwide wearables market will be nearly 500 million units by 2023, and the shipments of the smart home devices will be more than 13.9 billion in 2023. Actual marketing of the wearables far has exceeded expectations. For example, global shipments for wearables grew 9.9% during the third quarter of 2021 reaching 138.4 million units. With the popularity of diverse smart devices, it is natural for a user to utilize proper devices for different tasks in a multi-device environment. However, how to manage the devices owned by the user to better provide the required services needs to be studied and developed.

### SUMMARY

In general, example embodiments of the present disclosure provide a solution for service enhancement of a device and applications thereof.

In a first aspect, there is provided a device. The device comprises at least one processor and at least one memory storing instructions that, when executed by the at least one processor, cause the device at least to: cause a first application on the device to send, to an application registry on the device, a discovery request for discovering other applications; cause the application registry to determine, based on the discovery request, a second application registered in the application registry; and cause the application registry to send, to the first application, a discovery response indicating the second application.

In a second aspect, there is provided a method implemented at a device. The method comprises causing a first application on the device to send, to an application registry on the device, a discovery request for discovering other applications; causing the application registry to determine, based on the discovery request, a second application registered in the application registry; and causing the application registry to send, to the first application, a discovery response indicating the second application.

In a third aspect, there is provided an apparatus. The apparatus comprises means for causing, at a device, a first application on the device to send, to an application registry on the device, a discovery request for discovering other applications; means for causing the application registry to determine, based on the discovery request, a second application registered in the application registry; and means for causing the application registry to send, to the first application, a discovery response indicating the second application.

In a fourth aspect, there is provided a non-transitory computer readable medium comprising program instructions for causing an apparatus to perform at least the method according to the second aspect.

In a fifth aspect, there is provided a computer program comprising instructions, which, when executed by an apparatus, cause the apparatus at least to perform at least the method according to the second aspect.

In a sixth aspect, there is provided a device. The device comprises sending circuitry configured to cause a first application on the device to send, to an application registry on the device, a discovery request for discovering other applications; determining circuitry configured to cause the application registry to determine, based on the discovery request, a second application registered in the application registry; and sending circuitry configured to cause the application registry to send, to the first application, a discovery response indicating the second application.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Some example embodiments will now be described with reference to the accompanying drawings, where:

FIG. 1 illustrates an example environment in which example embodiments of the present disclosure can be implemented;

FIG. 2 illustrates a process flow of application service discovery according to some example embodiments of the present disclosure;

FIG. 3 illustrates an example process of application service discovery and access through the application exposure according to some example embodiments of the present disclosure;

FIG. 4 illustrates an example process of application service discovery between devices according to some example embodiments of the present disclosure;

FIG. 5 illustrates an example process of application service update according to some example embodiments of the present disclosure;

FIG. 6 illustrates a flowchart of a method implemented at the device according to some embodiments of the present disclosure;

FIG. 7 illustrates a simplified block diagram of a device that is suitable for implementing some example embodiments of the present disclosure; and

FIG. 8 illustrates a block diagram of an example of a computer readable medium in accordance with some example embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof. As used herein, “at least one of the following: <a list of two or more elements>” and “at least one of <a list of two or more elements>” and similar wording, where the list of two or more elements are joined by “and” or “or”. mean at least any one of the elements, or at least any two or more of the elements, or at least all the elements.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory (ies) that work together to cause an apparatus, such as a mobile phone or server, to perform various functions) and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, or other computing device.

The term “device” refers to any end device that may be capable to implement a service required by a user. By way of example rather than limitation, the device may comprise a smart phone, a tablet, a wearable terminal device, a portable computer, a desktop computer, image capture terminal devices such as digital cameras, gaming terminal devices, music storage and playback appliances, vehicle-mounted wireless terminal devices, laptop-embedded equipment (LEE), laptop-mounted equipment (LME), USB (Universal Serial Bus) dongles, smart devices, wireless customer-premises equipment (CPE), an Internet of Things (IoT) device, a watch, smart glasses or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “mobile device”, “end device”, “user device”, “device”, “terminal”, “user equipment” and “UE” may be used interchangeably.

As stated above, in recent years, smart devices and ecosystem hardware have experienced not only explosive growth but also enormous diversification. A variety of smart devices (for example, a watch, an earphone, a smart speaker, a smart TV, a smart refrigerator and a smart car, etc.) are productized for customized requirements and become increasingly popular in people's daily lives. For example, it is reported that the shipments of the worldwide wearables market will be nearly 500 million units by 2023, and the shipments of the smart home devices will be more than 13.9 billion in 2023. Actual marketing of the wearables far has exceeded expectations. For example, global shipments for wearables grew 9.9% during the third quarter of 2021 reaching 138.4 million units. With the popularity of diverse smart devices, it is natural for a user to utilize proper devices for different tasks in a multi-device environment. However, how to manage the devices owned by the user to better provide the required services needs to be studied and developed.

Automatic collaboration of devices (for example, mobile devices) and applications thereof is one hot topic for devices (for example, mobile devices) especially for the Internet of Things (IoT) booming triggered by 5G and beyond technologies. From the perspective of the user, a typical pain point in a multi-device environment is there is no collaboration of their devices and applications thereof. For example, it is natural that the end user wants his/her mobile phone could automatically enable voice control and hands-free mode while he/she is in driving and disable a working mode automatically when he/she leaves the car. For example, if the user sets a “Do not disturb” state on his/her phone, his/her demand should be “do not disturb me from any device or application thereon” instead of the current phone only. That is, there is a need to allow the state change of one of the devices or one application thereon to trigger action(s) of other device(s) or application(s) automatically based on some pre-defined policy by the end user.

Currently, there is no support to enable dynamic and automatic collaboration of devices (for example, mobile devices) and applications thereof instead of manual operation(s) by the user. However, without the automatic collaboration of devices (for example, mobile devices) and applications thereof, the user has to operate manually on each device and applications thereof. The more devices and applications the user has, the worse the situation is. Individual manual collaboration by the user is very inefficient and terrible. Therefore, enabling the collaboration of devices (for example, mobile devices) and applications thereof is still an important issue to be solved.

According to embodiments of the present disclosure, there is provided a scheme for service enhancement of a device and applications thereof. With this scheme, a device causes a first application on the device to send, to an application registry on the device, a discovery request for discovering other applications. Then, the device causes the application registry to determine, based on the discovery request, a second application registered in the application registry. Moreover, the device causes the application registry to send, to the first application, a discovery response indicating the second application.

This scheme supports service discovery by introducing the application registry. On this basis, it is allowed to enable the collaboration of devices and applications thereof. As such, it is possible to improve the user experience. Principle and embodiments of the present disclosure will be described in detail below with reference to the accompanying drawings.

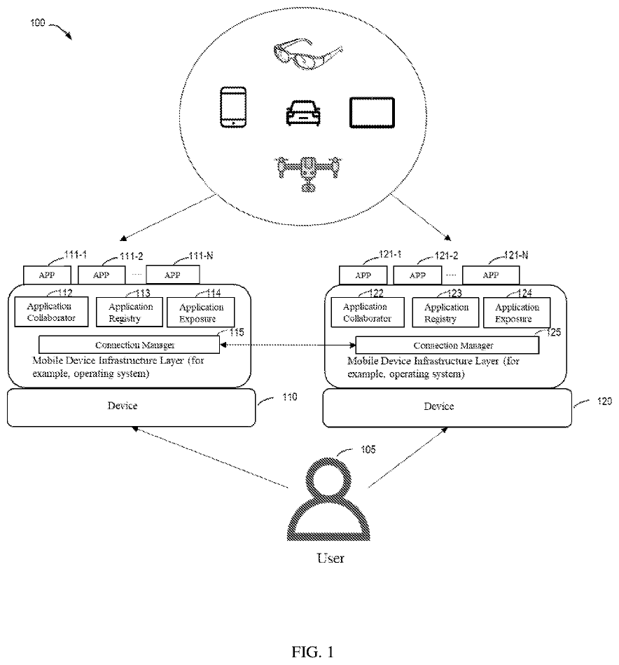

Reference is first made to FIG. 1, which illustrates an example environment 100 in which example embodiments of the present disclosure can be implemented. As shown in FIG. 1, the environment 100 comprises a user 105. The user 105 owns a device 110 and a device 120. The device 110 comprises applications 111-1 to 111-N. The device 110 further comprises some function, such as an application collaborator 112, an application registry 113, an application exposure 114, and a connection manager 115. Likewise, the device 120 comprises applications 121-1 to 121-N, an application collaborator 122, an application registry 123, an application exposure 124, and a connection manager 125. It is to be understood that the structures of the environment 100 and/or the devices 110 and 120 are shown only for purpose of illustration, without suggesting any limitation to the scope of the present disclosure. Embodiments of the present disclosure may also be applied to a different environment with a different structure and/or devices with different components.

Taking the device 110 as an example, similar features are applied to the device 120. In some example embodiments, the applications 111-1 to 111-N may be caused to be registered in the application registry 113. Then, one application (also referred to as a first application, for example, first application 111-1) of the applications 111-1 to 111-N may be caused to send, to the application registry 113, a discovery request for discovering other applications. For example, the discovery request may comprise a discovery criterion. The application registry 113 may be caused to determine, based on the discovery request, an application (also referred to as a second application, for example, the second application 111-2) registered in the application registry 113 that satisfies the discovery criterion, and then send, to the first application, a discovery response indicating the second application 111-2. The discovery response may indicate a service supported by the second application 111-2 and an address for accessing the service. As used herein, the service may be understood as an application programming interface (API).

In some example embodiments, the application exposure 114 may be caused to act as an intermedia for communication between the first application 111-1 and the second application 111-2. In this case, the application registry 113, may be caused to configure the address for accessing the service supported by the second application 111-2 to be an address of the application exposure 114. In this way, the first application 111-1 may communicate with the second application 111-2 via the application exposure 114 based on the address of the application exposure 114.

In some example embodiments, the application collaborator 112 may be configured to provide the user 105 with an API for managing a plurality of devices including the device 110. For example, the application collaborator 112 may be caused to discover, from the application registry 113, a plurality of applications and services supported by the plurality of applications. Then, the application collaborator 112 may be caused to, based on determining that the API is called by the user 105, determine the plurality of applications associated with the called API, and then perform an operation on the plurality of applications.

In some example embodiments, the connection manager 115 may be caused to establish, based on a trigger from the user 105, a connection in cooperation with the connection manager 125 on the device 120. In this case, the application registry 113 may be caused to discover an application and a service supported by the application on the device 120 via the connection. Thus, when receiving a discovery request from the first application 111-1, the application registry 113 may be caused to forward the discovery request to the application registry 123 via the connection and obtain a further discovery response indicating an application (also referred to a third application, for example, the third application 121-1) registered in the application registry 123. Then, the application registry 113 may be caused to generate the discovery response indicating the second application 111-2 and the third application 121-1, and further transmit the discovery response to the first application 111-1.

It is to be understood that two devices are shown in the environment 100 only for the purpose of illustration, without suggesting any limitation to the scope of the present disclosure. In some example embodiments, the environment 100 may comprise a further device to communicate with the devices 110 and 120.

The communications between devices in the environment 100 may follow any suitable communication standards or protocols, which are already in existence or to be developed in the future, such as Universal Mobile Telecommunications System (UMTS), long term evolution (LTE), LTE-Advanced (LTE-A), the fifth generation (5G) New Radio (NR), Wireless Fidelity (Wi-Fi) and Worldwide Interoperability for Microwave Access (WiMAX) standards, and employs any suitable communication technologies, including, for example, Multiple-Input Multiple-Output (MIMO), Orthogonal Frequency Division Multiplexing (OFDM), time division multiplexing (TDM), frequency division multiplexing (FDM), code division multiplexing (CDM), Bluetooth, ZigBee, and machine type communication (MTC), enhanced mobile broadband (cMBB), massive machine type communication (mMTC), ultra-reliable low latency communication (URLLC), Carrier Aggregation (CA), Dual Connection (DC), and New Radio Unlicensed (NR-U) technologies.

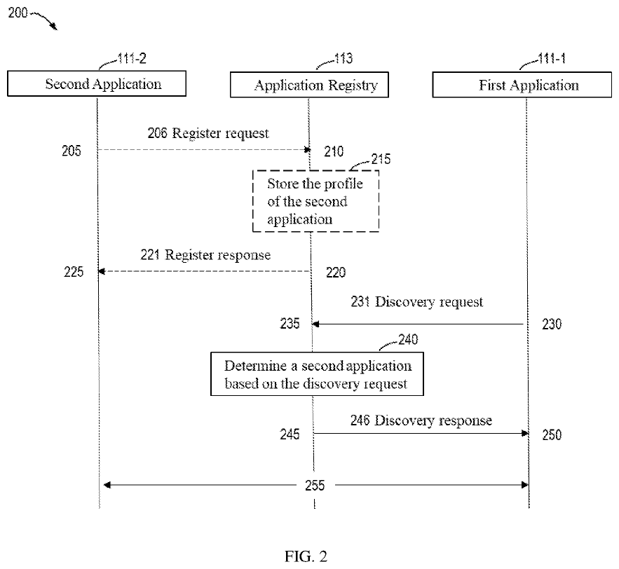

FIG. 2 illustrates a process flow 200 of application service discovery according to some example embodiments of the present disclosure. For the purpose of discussion, the process flow 200 will be described with reference to FIG. 1. It would be appreciated that although the process flow 200 has been described referring to the network environment 100 of FIG. 1, this process flow 200 may be likewise applied to other similar communication scenarios.

As shown in FIG. 2, the device 110 cause the first application 111-1 to send (230), to the application registry 113, a discovery request 231 for discovering other applications. On the receiving side, the application registry 113 receives (235) the discovery request 231. In this case, the application registry 113 may be used as a facility to support service discovery of applications running on the device 110. For example, the discovery request may comprise a discovery criterion. In this case, the device 110 may cause the application registry 113 to determine the discovery criterion from the discovery request 231. As an example, the discovery criterion may be based on at least one of: an application identifier, an application name, an application type, a service, or a service type. For example, the discovery criterion may comprise a supported API list.

Then, the device 110 causes the application registry to determine (240), based on the discovery request, the second application 111-2 registered in the application registry 113.

For example, the device 110 may cause the application registry 113 to determine the second application 111-2 on the basis that the second application 111-2 satisfies the discovery criterion. Alternatively or in addition, the device 110 may cause the application registry 113 to determine a plurality of devices including the second application 111-2 based on the discovery request. For example, the device 110 may cause the application registry 113 to determine the plurality of devices that satisfy the discovery criterion.

As shown in FIG. 2, the device 110 causes the application registry 113 to send (245), to the first application 111-1, a discovery response 246 indicating the second application 111-1. On the other side of the transmission, the first application 111-1 receives (250) the discovery response 246 from the application registry 113. For example, the discovery response 246 may indicate a service supported by the second application 111-2 and an address for accessing the service. For example, the address for accessing the service may comprise an address of the service. Then, the device 110 may cause the first application 111-1 to communicate (255) with the second application 111-2 based on the address of the service. For example, if a plurality of applications on the device 110 are determined by the application registry 113, the application registry 113 may be caused to provide the first application 111-1 with a list of the plurality of applications and application service instances relevant to the discovery criterion.

In some example embodiments, the device 110 may cause the application exposure

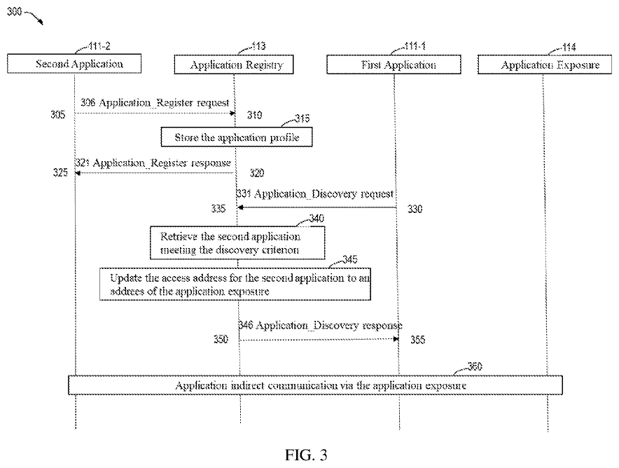

114 to act as an intermedia for communication between the first application 111-1 and the second application 111-2. For example, the device 110 may cause the application registry 113 to determine an address of the application exposure 114 as the address for accessing the service supported by the second application 111-2, and comprise the address of the application exposure 114 in the discovery response 246. In this case, the device 110 may cause the first application 111-1 to communicate with the second application 111-2 via the application exposure 114 based on the address of the application exposure 114. More related details will be described with reference to FIG. 3.

In the embodiments where the device 110 causes the application registry 113 to determine the plurality of devices, the discovery response 246 may indicate the plurality of devices. The device 110 may cause the application exposure 114 to act as an intermedia for communication between the first application 111-1 and a plurality of applications on the plurality of devices. In this case, the application registry 113 may be caused to determine a list of mappings between a plurality of addresses of the application registry 113 and a plurality of addresses for access a plurality of services supported by the plurality of applications. Then, the device 110 may cause the application registry 113 to determine a respective one of the plurality of addresses of the application exposure 114 as the address for accessing a respective service of the plurality of services when generating the discovery response 246. In this case, the device 110 may cause the first application 111-1 to communicate with the plurality of applications on the plurality of devices via the application exposure 114 based on the plurality of addresses of the application exposure 114.

Due to the reason that the application exposure 114 achieves the service exposure of applications, which avoids the privacy and security concerns of direct communication between applications by introducing service access controlling logic and log or audit logic to guarantee the safe communication between applications.

In some example embodiments, the device 110 may cause the application registry 113 to enable the applications on the device 110 to be registered in the application registry 113, when the application registry 113 is installed. In this case, there is no need for the device 110 to cause the applications on the device 110 to send requests for registering in the application registry 113. In another embodiments, the application running on the device 110 may trigger the “register request” to application registry 113 base on its own logic.

In some example embodiments, device 110 may cause the applications on device 110, for example, the second application 111-2, to be registered in the application registry 113 by sending requests for registering in the application registry 113. Just taking the second application 111-2 as an example to describe the following registration operations, it is to be understood that the registration operations are applicable to other applications on the device 110.

As an example, the device 110 may determine that the second application becomes operative for the first time. Then, the device 110 may cause the second application 111-2 to be registered in the application registry 113. In some example embodiments, as shown in FIG. 2, the device 110 may cause the second application 111-2 to send (205), to the application registry 113, a registry message (also referred to as a registry request) 206 comprising a profile of the second application 111-2. Accordingly, the application registry 113 may receive (210) the registry request 206. As an example, the profile of the second application 111-2 may comprise at least one of: an identifier of the second application 111-2. a name of the second application 111-2, application type information of the second application 111-2, a service supported by the second application 111-2, an address of a service, or service type information of a service. For example, the application or service type information may comprise the social network application or service, entertainment application or service, smart car application or service, etc. The application or service type information may be not necessary, as the application Registry 113 may be caused to generate the application or service type information based on other information comprised in the profile, for example, the supported services.

For example, the term “service instance” may be used to define the service provided by the first application 110, which is associated with the service and an address of the service. In this case, the profile of the second application 111-2 may comprise information related to the application instance, such as application instance identifier, an application name, a list of supported Application service instances. Alternatively or in addition, the information related to the application instance may comprise an address of the service instance that enables access to this service instance, for example, an Internet Protocol (IP)/Port address or Uniform Resource Identifier (URI), and APIs supported by this service instance. For example, there may be at least two kinds of APIs supported by one service instance, that is, a status query API and an operation request API. Taking a social network application as an example, the status query API may be caused to return the current status (for example, “Available”, “Busy”, “Do not disturb”, “Away”, “Offline”, etc.) of the second application 111-2 or the user 105. The operation request API may be caused to change the status to a requested status. For example, if the user 105 doesn't want to be disturbed, the status may be changed to “Do not disturb”, “busy” or “Offline”. For example, for a smart car application, the status query API may be caused to return the current status of the car, for example, “running, parked”, “locked”, “unlocked”, etc. The operation request API may be caused to support controlling the devices on the car.

As shown in FIG. 2, the device 110 may cause the application registry 113 to store (215) the profile of the second application 111-2 for further use. Then, the device 110 may cause the application registry 113 to send (220), to the second application 111-2, a registry response 221 indicating the success of the registration. Accordingly, the second application 111-2 may receive (225), from the application registry 113, the registry response 221.

In some example embodiments, the device 110 may cause the first application 111-1 to obtain the latest information on the discovered application. For example, the device 110 may cause the second application 111-2 to send, to the application registry 113, a registry update message comprising an updated profile of the second application 111-2, if it determines that a service supported by the second application 111-2 is changed. Then, the device 110 may cause the application registry 113 to store the updated profile of the second application 111-2. As the device 110 may cause the application registry 113 to determine that the first application 111-1 discovered the second application 111-2, the device 110 may further cause the application registry 113 to send, to the first application 111-1, notification about the changed service of the second application 111-2. In another embodiments, the application running on the device 110 may trigger the “register update reauest” to application registry 113 base on its own logic, for example, after software update, the the application running on the device 110 detects its own service is also updated/enhanced, then, it will trigger “register update reauest” to application registry 113.

For example, the second application 111-2 may change its services (APIs), for example, one more new service/API may be supported now. The application registry 113 may notify the first application 111-1 that the services supported by the second application 111-2 are changed. To implement this, the application registry 113 may remember all the application service discoveries performed before. Once one application service discovered is changed, the application registry 113 may be caused to notify related applications that discovered the service. In this case, once a service supported by one service provider application is discovered, applications that discovered this service may use the service API discovered to get the service from the service provider application.

Alternatively or in addition, the device 110 may cause the first application 111-1 to subscribe to the second application 111-2 for notification of service change. Then, based on determining that the service is changed, the device 110 may cause the second application 111-2 to send, to the first applicaiton 111-1, the notification of the service change. For example, the second application 111-2 may support the API status_subscribe (Application ID, expected status). In this case, the first application 111-1 may get any status change report through call this API to the second application 111-2 directly or through the application exposure 114.

In some example embodiments, the device 110 may cause the second application 111-2 to be de-registered in a variety of ways. For example, the device 110 may cause the second application 111-2 to determine that the second application 111-2 is to be shut down.

Then, the device 110 may cause the second application 111-2 to be de-registered in the application registry 113. Alternatively or in addition, the device 110 may cause the application registry 113 to determine periodically whether the second application 111-2 is available. For example, the device 110 may cause the application registry 113 to de-register the second application 111-2 based on determining that the second application 111-2 is unavailable. In another embodiments, the application running on the device 110 may trigger the “de-register update” to application registry 113 base on its own logic. For example, when the application quit from running.

In some example embodiments, the device 110 may cause the connection manager (also referred to as the first connection manager) 115 on the device 110 to establish an connection with another connection manager (also referred to as the second connection manager) 125 on the device 120. For example, the device 110 may cause the first connection manager 115 to receive a trigger, from the user 105, for establishing the connection. Then, the device 110 may cause the first connection manager 115 to establish, based on receiving the trigger, the connection in cooperation with the second connection manager 125. For example, device 110 may cause the first connection manager 115 to send a request to the second connection manager 125. The request may be for establishing the connection and comprises authentication information. Then, the device 110 may cause the first connection manager 115 to receive, from the second connection manager 125, a response comprising an acknowledgment (ACK) for the request. Moreover, the device 110 may cause the first connection manager 115 to store information on the connection including an address of the device 120.

As an example, based on the destination device address of the device 120 provided by the user 105, the first connection manager 115 may be caused to contact the second connection manager 125 for the establishment of an authorized connection by sending an Authorized Connection request message with the necessary authentication information. Then, at the destination device 120, the user interface may be popped up to request the confirmation from the user 105. Based on the confirmation, an Authorized Connection ACK may be sent back to device 110. Further, information associated with the connection, for example, the identifier of the device 110 may be stored in the device 120. Besides, based on the Authorized Connection ACK received at the device 110, the information associated with the connection, for example, the identifier of the device 120, may be saved in the device 110.

In this case, based on the discovery request 231 from the first application 110-1. the device 110 may cause the application registry 113 to send the discovery request 231 to the application registry 123 on the device 120 via the connection. The device 120 may cause the application registry 123 to determine an application (also referred to as a third application) 121-1 registered in the application registry 123 based on the discovery request 231. Then, the device 120 may cause the application registry 123 to transmit, to the application registry 113 via the connection, a further discovery response indicating the third application 121-1. Then, the device 110 may cause the application registry 113 to generate the discovery response 246 indicating the second application and the third application.

The connection managers may be used as facilities to build and maintain the authorized connections among devices owned by the user 105 for the collaboration of application registries and application exposures on these devices. In this way, application registries and application exposures among different devices may work together to support service discoveries and exposures of applications running on the devices.

In some example embodiments, the device 110 may cause the application collaborator 112 on the device 110 to provide the user 105 with an API for managing a plurality of devices including the device 110 and a plurality of applications on the plurality of devices. For example, the API may comprise an API for setting the plurality of applications to a certain state. In this case, the API may be called in the scenario when the user 105 is busy in metaverse's virtual world, for example, when talking with others in the metaverse's application, or in a virtual meeting, the user 105 wants to avoid disturbing in the real world, that is, the user 105 wants his mobile phone or other social network applications to be set to “Do not disturb” automatically. As another example, the API may comprise an API for turning on or off the plurality of devices. The API may be called in the scenario when the user 105 leaves home for working, the user 105 wants to turn off all lamps in the house. As a further example, the API may comprise an API for determining states of the plurality of devices. The API may be called in the scenario when the user 105 wants to know the overall states of owned devices.

The device 110 may cause the application collaborator 112 to send, to the application registry 113, a trigger for discovering the plurality of applications and services supported by the plurality of applications, and then cause the application collaborator 113 to maintain information on the plurality of applications and the services supported by the plurality of applications. Further, the device 110 may cause the application collaborator 112 to determine that the API is called by the user 105. Then, the device 110 may cause the application collaborator 112 to determine the plurality of applications associated with the called API. On this basis, the device 110 may cause the application collaborator 112 to perform an operation on the plurality of applications.

For example, the application collaborator 112 may be caused to trigger the service discovery to the application registry 113 to detect all available applications/services owned by the user 105. The application collaborator 112 may maintain the list of available applications/services owned by the user 105. As an example, when an API to set all social network applications to “Busy”, the application collaborator 112 may be caused to retrieve all applications in the social network application list it maintained, and call the status update API for each application to set the status to “Busy”.

In some example embodiments, the device 110 may cause the application collaborator 112 to provide the user 105 with an interface for configuring an application collaboration policy indicating an action criterion and at least one action to be performed if the action criterion is satisfied. For example, the application collaborator 112 may be caused to provide the interface to the user 105 to provision application collaboration policy directly based on user demand. Following is one example of an application collaboration policy:
Action Criteria: The status of a social application is in talking.
Action(s): Update the state of the mobile phone to “Busy”, which means that all incoming calls during the time in “Busy” will be rejected with a busy tone.

In this way, it is allowed to enable service discovery and exposure. Moreover, on this basis, a simple, efficient and quick collaboration between applications in a device may be achieved. Moreover, based on the connection managers on multiple devices, the application collaborators can provide the API to enable efficient collaboration of the multiple devices and applications thereof.

FIG. 3 illustrates an example process 300 of application service discovery and access through the application exposure according to some example embodiments of the present disclosure. Specifically, FIG. 3 shows a procedure of application service discovery and access through application exposure. For the purpose of discussion, the process 300 will be described with reference to FIG. 1. It would be appreciated that although the process 300 has been described in the network environment 100 of FIG. 1, this process flow may be likewise applied to other communication scenarios.

As shown in FIG. 3, the device 110 causes the second application 111-2 to send (305) an Application_Register request 306 to the application registry 113. Accordingly, the device 110 causes the application registry 113 to receive (310) the Application_Register request 306 from the second application 111-2. For example, the Application_Register request 306 comprises an application profile of the second application 111-2. Then, the device 110 causes the application registry 113 to store (315) the application profile of the second application 111-2. The device 110 causes the application registry 113 to send (320) an Application_Register response 321 to the second application 111-2. On the receiving side, the device 110 causes the second application 111-2 to receive (325) the Application_Register response 321.

The device 110 causes the first application 111-1 to send (330) an Application_Discovery request 331 to the application registry 113. Accordingly, the device 110 causes the application registry 113 to receive (335) the Application_Discovery request 331 from the first application 111-1. For example, the Application_Discovery request 331 comprises a discovery criterion. Then, the device 110 causes the application registry 113 to retrieve (340) the second application 111-2 meeting the discovery criterion. To improve communication security, the device 110 causes the application registry 113 to update (345) the access address for the second application 111-2 to an address of the application exposure 114, and then on this basis, the device 110 causes the application registry 113 to generate an Application_Discovery response 346. Then, device 110 causes the application registry 113 to send (350) an Application_Discovery response 346 to the first application 111-1. The device 110 further causes the first application 111-1 to receive (355) the Application_Discovery response 346 from the application registry 113. Then, at 360, the application indirect communication between the first application 111-1 and the second application 111-2 is enabled via the application exposure 114.

In this way, it is allowed to support service discovery of applications running on the devices based on new API Application_Register and Application_Discovery. Besides, application exposure can improve communication security and privacy protection.

All operations and features as described above with reference to FIG. 2 are likewise applicable to the process 300 and have similar effects. For the purpose of simplification, the details will be omitted.

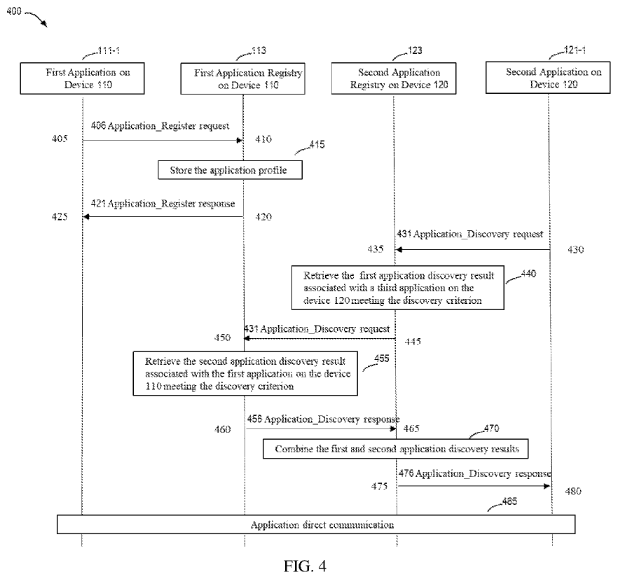

FIG. 4 illustrates an example process 400 of application service discovery between devices according to some example embodiments of the present disclosure. Specifically, FIG. 4 shows an application service discovery procedure among multiple devices. For the purpose of discussion, the process 400 will be described with reference to FIG. 1. It would be appreciated that although the process 400 has been described in the network environment 100 of FIG. 1, this process flow may be likewise applied to other communication scenarios.

As shown in FIG. 4, the device 110 causes the first application 111-1 to send (405) an Application_Register request 406 to the first application registry 113 on device 110. Accordingly, the device 110 causes the first application registry 113 to receive (410) the Application_Register request 406 from the first application 111-1. For example, the Application_Register request 306 comprises an application profile of the first application 111-1. Then, the device 110 causes the first application registry 113 to store (415) the application profile of the first application 111-1. The device 110 causes the first application registry 113 to send (420) an Application_Register response 421 to the first application 111-1. On the receiving side, the device 110 causes the first application 111-1 to receive (425) the Application_Register response 421.

The device 120 causes the second application 121-1 to send (430) an Application_Discovery request 431 to the second application registry 123. Accordingly, the device 120 causes the application registry 123 to receive (435) the Application_Discovery request 431 from the second application 121-1. For example, the Application_Discovery request 331 comprises an discovery criterion. Then, the device 120 causes the second application registry 123 to retrieve (440) the first application discovery result associated with a third application on the device 120 meeting the discovery criterion.

In this case, a connection has been established between the first application registry 113 and the second application registry 123. The device 120 causes the second application registry 123 to send (445) the Application_Discovery request 431 to the first application registry 113 via the connection. Accordingly, the device 110 causes the first application registry 113 to receive (450) the Application_Discovery request 431 from the second application registry 123 via the connection. The device 120 causes the first application registry 113 to retrieve (455) the second application discovery result associated with the first application 111-1 on the device 110 meeting the discovery criterion, and on this basis, the device 120 causes the first application registry 113 to generate the Application_Discovery response 456. The device 110 causes the first application registry 113 to send (460) an Application_Discovery response 456 to the application registry 123 via the connection. On the receiving side, the device 120 causes the second application 121-1 to receive (465) the Application_Discovery response 456 from the first application registry 113 via the connection.

The device 120 causes the application registry 123 to combine (470) the first and second application discovery results, and on this basis, generate an Application_Discovery response 476. Then, the device 120 causes the application registry 123 to send (475) the Application_Discovery response 476 to the second application 121-1. Accordingly, the device 120 causes the second application 121-1 to receive (480) the Application_Discovery response 476 from the application registry 123. Then, at 485, the application direct communication between the first application 111-1 and the second application 111-2 is enabled. In some example embodiments, the application exposure function may also be added to guarantee the security and privacy protection in the above communication.

All operations and features as described above with reference to FIG. 2 are likewise applicable to the process 400 and have similar effects. For the purpose of simplification, the details will be omitted.

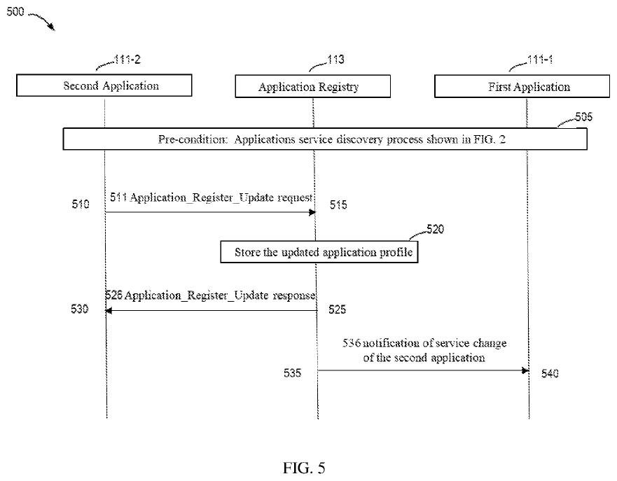

FIG. 5 illustrates an example process of application service update according to some example embodiments of the present disclosure. For the purpose of discussion, the process 500 will be described with reference to FIG. 1. It would be appreciated that although the process 500 has been described in the network environment 100 of FIG. 1, this process flow may be likewise applied to other communication scenarios.

At 505, the application service discovery process as shown in FIG. 2 has been performed, and thus the second application 111-2 has been registered in the application registry 113. For example, if a service supported by the second application 111-2 has been changed, the device 110 causes the second application 111-2 to send (510), to the application registry 113, an Application_Register_Update request 511 to update its profile. Accordingly, the device 110 causes the application registry 113 to receive (515) the Application_Register_Update request 511.

Then, the device 110 causes the application registry 113 to store (520) the updated application profile of the second application 111-2. The device 110 causes the application registry 113 to send (525) an Application_Register_Update response 526 to the second application 111-2. On the receiving side, the device 110 causes the second application 111-2 to receive (530) the Application_Register_Update response 526. As the first application 111-1 discovered the second application 11-2, the device 110 causes the application registry 113 to send (535), to the first application 110-1, notification 536 of service change of the second application 111-2. Accordingly, the device 110 causes the first application 110-1 to receive (540) the notification 536 of service change of the second application 111-2.

All operations and features as described above with reference to FIG. 2 are likewise applicable to the process 500 and have similar effects. For the purpose of simplification, the details will be omitted.

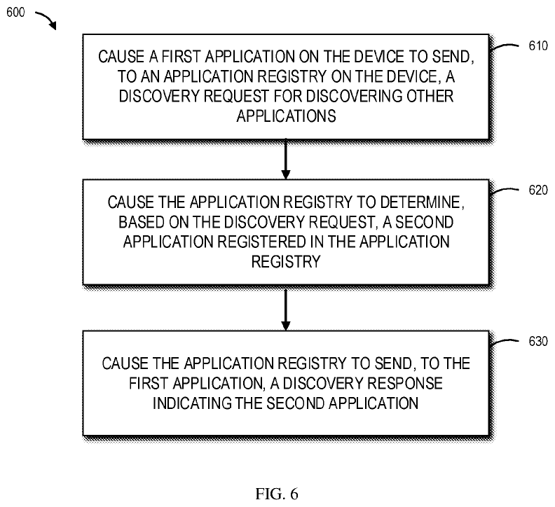

FIG. 6 illustrates a flowchart 600 of a method implemented at the device 110 according to some embodiments of the present disclosure. For the purpose of discussion, the method 600 will be described from the perspective of the device 110 with reference to FIG. 1.

At block 610, the device 110 causes a first application on the device to send, to an application registry on the device, a discovery request for discovering other applications.

At block 620, the device 110 causes the application registry to determine, based on the discovery request, a second application registered in the application registry. At block 630, the device 110 causes the application registry to send, to the first application, a discovery response indicating the second application.

In some example embodiments, the device 110 further causes the second application to be registered in the application registry. In some example embodiments, the device 110 causes the second application to be registered in the application registry by: causing the second application to send, to the application registry, a registry message comprising a profile of the second application, and causing the application registry to store the profile of the second application. In some example embodiments, the profile of the second application 111-2 comprises at least one of: an identifier of the second application; a name of the second application; application type information of the second application; a service supported by the second application; an address of a service; or service type information of a service.

In some example embodiments, the device 110 further, in accordance with a determination that a service supported by the second application is changed, causes the second application to send, to the application registry, a registry update message comprising an updated profile of the second application; and causes the application registry to store the updated profile of the second application. In some example embodiments, the device 110 further causes the application registry to send, to the first application, notification about the changed service.

In some example embodiments, the device 110 further causes the first application to subscribe to the second application for notification of a service change; and based on determining that the service is changed, causes the second application to send, to the first application, the notification of the service change.

In some example embodiments, the device 110 cause the second application to be registered in the application registry by: determining that the second application becomes operative for the first time; and based on determining that the second application becomes operative for the first time, causing the second application to be registered in the application registry.

In some example embodiments, the device 110 further causes the second application to determine that the second application is to be shut down; and causes the second application to be de-registered in the application registry based on determining that the second application is to be shut down.

In some example embodiments, the device 110 further causes the application registry to determine periodically whether the second application is available; and causes the application registry to de-register the second application based on determining that the second application is unavailable.

In some example embodiments, the device 110 further causes a first connection manager on the device 110 to receive a trigger, from a user of the device 110, for establishing a connection between the device 110 and a further device; causes the first connection manager to establish, based on receiving the trigger, the connection in cooperation with a second connection manager on the further device; and causes the first connection manager to store information on the connection including an address of the further device.

In some example embodiments, the device 110 cause the first connection manager to establish the connection in cooperation with the second connection manager by: causing the first connection manager to send a request to the second connection manager, the request being for establishing the connection and comprising authentication information; and causing the first connection manager to receive, from the second connection manager, a response comprising an acknowledgement for the request.

In some example embodiments, the device 110 further causes the application registry to send the discovery request to a further application registry on the further device via the connection; causes the application registry to receive, from the further application registry via the connection, a further discovery response indicating a third application registered in the further application registry; and causes the application registry to generate the discovery response indicating the second application and the third application.

In some example embodiments, the discovery response indicates a service supported by the second application and an address for accessing the service. In some example embodiments, the address for accessing the service comprises an address of the service, and the device 110 further causes the first application to communicate with the second application based on the address of the service.

In some example embodiments, the address for accessing the service comprises an address of an application exposure on the device 110, and wherein the device 110 further causes the first application to communicate with the second application via the application exposure based on the address of the application exposure. In some example embodiments, the device 110 further causes an application collaborator on the device 110 to provide a user of the device 110 with an application programming interface, API, for managing a plurality of devices including the device 110 and a plurality of applications on the plurality of devices.

In some example embodiments, the API comprises one of the following: an API for setting the plurality of applications to a certain state; an API for turning on or off the plurality of devices; or an API for determining states of the plurality of devices. In some example embodiments, the device 110 further causes the application collaborator to send, to the application registry, a trigger for discovering the plurality of applications and services supported by the plurality of applications; and causes the application collaborator to maintain information on the plurality of applications and the services supported by the plurality of applications.

In some example embodiments, the device 110 further causes the application collaborator to determine that the API is called by the user; causes the application collaborator to determine the plurality of applications associated with the called API; and causes the application collaborator to perform an operation on the plurality of applications. In some example embodiments, the device 110 further causes the application collaborator to provide the user with an interface for configuring an application collaboration policy indicating an action criterion and at least one action to be performed if the action criterion is satisfied.

In some example embodiments, the device 110 causes the application registry to determine the second application by: causing the application registry to determine a discovery criterion from the discovery request; and causing the application registry to determine that the second application satisfies the discovery criterion. In some example embodiments, the discovery criterion is based on at least one of: an application identifier; an application name; an application type; a service; or a service type.

In some example embodiments, an apparatus capable of performing the method 600 (for example, the device 110) may comprise means for performing the respective steps of the method 600. The means may be implemented in any suitable form. For example, the means may be implemented in a circuitry or software module.

In some example embodiments, the apparatus comprises means for causing a first application on the device to send, to an application registry on the device, a discovery request for discovering other applications; means for causing the application registry to determine, based on the discovery request, a second application registered in the application registry; and means for causing the application registry to send, to the first application, a discovery response indicating the second application.

In some example embodiments, the apparatus further comprises means for causing the second application to be registered in the application registry. In some example embodiments, the means for causing the second application to be registered in the application registry comprises means for causing the second application to send, to the application registry, a registry message comprising a profile of the second application; and means for causing the application registry to store the profile of the second application.

In some example embodiments, the profile of the second application comprises at least one of: an identifier of the second application; a name of the second application; application type information of the second application; a service supported by the second application; an address of a service; or service type information of a service. In some example embodiments, the apparatus further comprises means for, in accordance with a determination that a service supported by the second application is changed, causing the second application to send, to the application registry, a registry update message comprising an updated profile of the second application; and means for causing the application registry to store the updated profile of the second application.

In some example embodiments, the apparatus further comprises means for causing the application registry to send, to the first application, notification about the changed service. In some example embodiments, the apparatus further comprises means for causing the first application to subscribe to the second application for notification of a service change; and means for based on determining that the service is changed, causing the second application to send, to the first application, the notification of the service change.

In some example embodiments, the means for causing the second application to be registered in the application registry comprises means for determining that the second application becomes operative for the first time; and means for, based on determining that the second application becomes operative for the first time, causing the second application to be registered in the application registry.

In some example embodiments, the apparatus further comprises means for causing the second application to determine that the second application is to be shut down; and means for causing the second application to be de-registered in the application registry based on determining that the second application is to be shut down. In some example embodiments, the apparatus further comprises means for causing the application registry to determine periodically whether the second application is available; and means for causing the application registry to de-register the second application based on determining that the second application is unavailable.

In some example embodiments, the apparatus further comprises means for causing a first connection manager on the device to receive a trigger, from a user of the device, for establishing a connection between the device and a further device; means for causing the first connection manager to establish, based on receiving the trigger, the connection in cooperation with a second connection manager on the further device; and means for causing the first connection manager to store information on the connection including an address of the further device.

In some example embodiments, the means for causing the first connection manager to establish the connection in cooperation with the second connection manager comprises: means for causing the first connection manager to send a request to the second connection manager, the request being for establishing the connection and comprising authentication information; and means for causing the first connection manager to receive, from the second connection manager, a response comprising an acknowledgement for the request.

In some example embodiments, the apparatus further comprises means for causing the application registry to send the discovery request to a further application registry on the further device via the connection; means for causing the application registry to receive, from the further application registry via the connection, a further discovery response indicating a third application registered in the further application registry; and means for causing the application registry to generate the discovery response indicating the second application and the third application.

In some example embodiments, the discovery response indicates a service supported by the second application and an address for accessing the service. In some example embodiments, the address for accessing the service comprises an address of the service, and the apparatus further comprises means for causing the first application to communicate with the second application based on the address of the service. In some example embodiments, the address for accessing the service comprises an address of an application exposure on the device, and the apparatus further comprises means for causing the first application to communicate with the second application via the application exposure based on the address of the application exposure.

In some example embodiments, the apparatus further comprises means for causing an application collaborator on the device to provide a user of the device with an application programming interface, API, for managing a plurality of devices including the device and a plurality of applications on the plurality of devices. In some example embodiments, the API comprises one of the following: an API for setting the plurality of applications to a certain state; an API for turning on or off the plurality of devices; or an API for determining states of the plurality of devices.

In some example embodiments, the apparatus further comprises means for causing the application collaborator to send, to the application registry, a trigger for discovering the plurality of applications and services supported by the plurality of applications; and means for causing the application collaborator to maintain information on the plurality of applications and the services supported by the plurality of applications.

In some example embodiments, the apparatus further comprises means for causing the application collaborator to determine that the API is called by the user; means for causing the application collaborator to determine the plurality of applications associated with the called API; and means for causing the application collaborator to perform an operation on the plurality of applications.

In some example embodiments, the apparatus further comprises means for causing the application collaborator to provide the user with an interface for configuring an application collaboration policy indicating an action criterion and at least one action to be performed if the action criterion is satisfied.

In some example embodiments, the means for causing the application registry to determine the second application comprises means for causing the application registry to determine a discovery criterion from the discovery request; and means for causing the application registry to determine that the second application satisfies the discovery criterion. In some example embodiments, the discovery criterion is based on at least one of: an application identifier; an application name; an application type; a service; or a service type.

In some embodiments, the apparatus further comprises means for performing other steps in some embodiments of the method 600. In some embodiments, the means comprises at least one processor and at least one memory including computer program code. The at least one memory and computer program code are configured to, with the at least one processor, cause the performance of the apparatus.

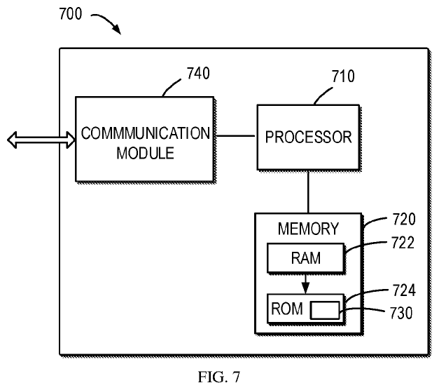

FIG. 7 illustrates a simplified block diagram of a device 700 that is suitable for implementing some example embodiments of the present disclosure. The device 700 may be provided to implement the communication device, for example, the device 110, or the device 120 as shown in FIG. 1. As shown, the device 700 includes one or more processors 710, one or more memories 720 coupled to the processor 710, and one or more communication modules 740 coupled to the processor 710.

The communication module 740 is for bidirectional communications. The communication module 740 has at least one antenna to facilitate communication. The communication interface may represent any interface that is necessary for communication with other network elements.

The processor 710 may be of any type suitable to the local technical network and may include one or more of the following: general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

The memory 720 may include one or more non-volatile memories and one or more volatile memories. Examples of the non-volatile memories include, but are not limited to, a Read Only Memory (ROM) 724, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 722 and other volatile memories that will not last in the power-down duration.

A computer program 730 includes computer executable instructions that are executed by the associated processor 710. The program 730 may be stored in the ROM 724. The processor 710 may perform any suitable actions and processing by loading the program 730 into the RAM 722.

The embodiments of the present disclosure may be implemented by means of the program 730 so that the device 700 may perform any process of the disclosure as discussed with reference to FIGS. 2 to 6. The embodiments of the present disclosure may also be implemented by hardware or by a combination of software and hardware.

In some example embodiments, the program 730 may be tangibly contained in a computer readable medium which may be included in the device 700 (such as in the memory 720) or other storage devices that are accessible by the device 700. The device 700 may load the program 730 from the computer readable medium to the RAM 722 for execution. The computer readable medium may include any types of tangible non-volatile storage, such as ROM, EPROM, a flash memory, a hard disk, CD, DVD, and the like.

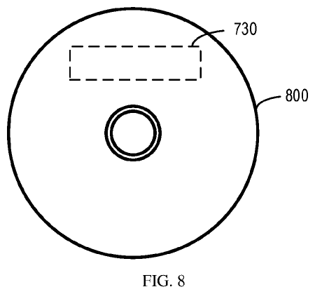

FIG. 8 illustrates a block diagram of an example of a computer readable medium 800 in accordance with some example embodiments of the present disclosure. The computer readable medium 800 has the program 730 stored thereon. It is noted that although the computer readable medium 800 is depicted in form of CD or DVD in FIG. 8, the computer readable medium 800 may be in any other form suitable for carry or hold the program 730.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, apparatus, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method as described above with reference to FIG. 6. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, apparatus or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, apparatus, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. The term “non-transitory,” as used herein, is a limitation of the medium itself (i.e., tangible, not a signal) as opposed to a limitation on data storage persistency (e.g., RAM vs. ROM).

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-27. (canceled)

28. A device comprising:
at least one processor; and
at least one memory storing instructions that, when executed by the at least one processor, cause the device at least to:
cause a first application on the device to send, to an application registry on the device, a discovery request for discovering other applications;
cause the application registry to determine, based on the discovery request, a second application registered in the application registry; and
cause the application registry to send, to the first application, a discovery response indicating the second application.

29. The device of claim 28, wherein the device is further caused to:
cause the second application to be registered in the application registry.

30. The device of claim 29, wherein the device is caused to cause the second application to be registered in the application registry by:
causing the second application to send, to the application registry, a registry message comprising a profile of the second application; and
causing the application registry to store the profile of the second application.

31. The device of claim 30, wherein the profile of the second application comprises at least one of:
an identifier of the second application;
a name of the second application;
application type information of the second application;
a service supported by the second application;
an address of a service; or
service type information of a service.

32. The device of claim 29, wherein the device is caused to cause the second application to be registered in the application registry by:
determining that the second application becomes operative for the first time; and
based on determining that the second application becomes operative for the first time, causing the second application to be registered in the application registry.

33. The device of claim 28, wherein the device is further caused to:
cause a first connection manager on the device to receive a trigger, from a user of the device, for establishing a connection between the device and a further device:
cause the first connection manager to establish, based on receiving the trigger, the connection in cooperation with a second connection manager on the further device; and
cause the first connection manager to store information on the connection including an address of the further device.

34. The device of claim 33, wherein the device is caused to cause the first connection manager to establish the connection in cooperation with the second connection manager by:
causing the first connection manager to send a request to the second connection manager, the request being for establishing the connection and comprising authentication information; and
causing the first connection manager to receive, from the second connection manager, a response comprising an acknowledgement for the request.

35. The device of claim 33, wherein the device is further caused to:
cause the application registry to send the discovery request to a further application registry on the further device via the connection;
cause the application registry to receive, from the further application registry via the connection, a further discovery response indicating a third application registered in the further application registry; and
cause the application registry to generate the discovery response indicating the second application and the third application.

36. The device of claim 28, wherein the discovery response indicates a service supported by the second application and an address for accessing the service.

37. The device of claim 9, wherein the address for accessing the service comprises an address of the service, and wherein the device is further caused to:
cause the first application to communicate with the second application based on the address of the service.

38. The device of claim 36, wherein the address for accessing the service comprises an address of an application exposure on the device, and wherein the device is further caused to:
cause the first application to communicate with the second application via the application exposure based on the address of the application exposure.

39. The device of claim 28, wherein the device is further caused to:
cause an application collaborator on the device to provide a user of the device with an application programming interface, API, for managing a plurality of devices including the device and a plurality of applications on the plurality of devices, wherein the API comprises at least one of the following:
an API for setting the plurality of applications to a certain state:
an API for turning on or off the plurality of devices; or
an API for determining states of the plurality of devices.

40. The device of claim 39, wherein the device is further caused to:
cause the application collaborator to send, to the application registry, a trigger for discovering the plurality of applications and services supported by the plurality of applications: and
cause the application collaborator to maintain information on the plurality of applications and the services supported by the plurality of applications.

41. The device of claim 39, wherein the device is further caused to:
cause the application collaborator to determine that the API is called by the user:
cause the application collaborator to determine the plurality of applications associated with the called API; and
cause the application collaborator to perform an operation on the plurality of applications.

42. The device of claim 39, wherein the device is further caused to:
cause the application collaborator to provide the user with an interface for configuring an application collaboration policy indicating an action criterion and at least one action to be performed if the action criterion is satisfied.

43. The device of claim 28, wherein the device is caused to cause the application registry to determine the second application by:
causing the application registry to determine a discovery criterion from the discovery request; and
causing the application registry to determine that the second application satisfies the discovery criterion.

44. The device of claim 28 further comprising at least one antenna.

45. A user equipment comprising the device of claim 28.

46. A method comprising:
causing, at a device, a first application on the device to send, to an application registry on the device, a discovery request for discovering other applications;
causing the application registry to determine, based on the discovery request, a second application registered in the application registry; and
causing the application registry to send, to the first application, a discovery response indicating the second application.

47. A computer program comprising instructions, which, when executed by an apparatus, cause the apparatus at least to:
cause, at a device, a first application on the device to send, to an application registry on the device, a discovery request for discovering other applications;
cause the application registry to determine, based on the discovery request, a second application registered in the application registry; and
cause the application registry to send, to the first application, a discovery response indicating the second application.
